(19) United States
(12) Patent Application Publication
(10) Pub. No.: US 2026/0029773 A1
(43) Pub. Date: Jan. 29, 2026

(54) DIMENSIONAL COMPENSATION SPECIFICATION VIA COLOR WITHIN OBJECT MODEL DATA

(71) Applicant: PERIDOT PRINT LLC, Palo Alto, CA (US)

(72) Inventors: Axel Pairo Manero, Sant Cugat del Valles (ES); Manuel Freire Garcia, Sant Cugat del Valles (ES); Alex Carruesco Llorens, Sant Cugat del Valles (ES)

(21) Appl. No.: 18/786,537

(22) Filed: Jul. 28, 2024

(51) Int. Cl. G05B 19/4099; B29C 64/386; B33Y 50/00

(52) U.S. Cl. CPC G05B 19/4099; B29C 64/386; B33Y 50/00; G05B 2219/49023

(57) ABSTRACT

An additive manufacturing apparatus includes a processor and a memory storing program code. The program code is executable by a processor to receive object model data representing a geometry of an object and specifying a color value for a region of the object. The object is to be physically generated via additive manufacturing. The program code is executable by the processor to determine a dimensional compensation corresponding to the color value specified for the region of the object. The program code is executable by the processor to generate instructions for physically generating the object, based on the geometry of the object and the dimensional compensation, and such that the dimensional compensation is applied to just the region of the object for which the color value has been specified. The program code is executable by the processor to execute the instructions to physically generate the object.

### BACKGROUND

Additive manufacturing, which can also be referred to as three-dimensional (3D) printing, permits the physical generation of 3D objects from computer-aided design (CAD) models. In comparison to traditional manufacturing techniques, such as subtractive manufacturing techniques like milling and formative manufacturing techniques like molding, additive manufacturing involves adding material in layers to create the final product. Different additive manufacturing techniques include stereolithography (SLA), fused deposition modeling (FDM), selective laser sintering (SLS), high speed sintering (HSS), and multi jet fusion (MJF), among others.

In SLA, an energy source is used to cure liquid resin into hardened material to form an object. In FDM, a thermoplastic filament may be extruded through a heated nozzle; the filament hardens during cooling to form an object. In SLS, a point energy source, such as a laser, is used to selectively sinter powder into hardened material to form an object. In HSS and MJF, a print agent is selectively applied to successive layers of build material powder to cause subsequent fusion to form successive layers of an object when each layer of build material is subjected to a generally non-selective energy source.

### BRIEF DESCRIPTION OF THE DRAWINGS

FIG. 1 is a diagram of an example model of an example object having regions to which different dimensional compensations are to be applied to accurately physically generate the object via additive manufacturing.

FIG. 2 is a diagram of example object model data for an object that specifies colors corresponding to dimensional compensations to be applied to respective object regions to accurately additively manufacture the object.

FIG. 3 is a diagram of a specific example of color values of a color specified by the object model data for an object region, which correspond to dimensional compensations to be applied to that region.

FIG. 4A is a diagram of an example as to how a color value can be used to specify a negative or a positive dimensional compensation.

FIG. 4B is a diagram of an example as to how a color value can be used to specify both an offset dimensional compensation and a scaling dimensional compensation.

FIG. 4C is a diagram of an example as to how a color value can be used to specify both a dimensional compensation to be applied to an object region and a color that the region is to have when generated.

FIG. 5A is a diagram of an example function for determining the dimensional compensation to apply to an object region from a color value specified by the object model data for that region.

FIG. 5B is a diagram of an example lookup table for determining the dimensional compensation to apply to an object region from a color value specified by the object model data for that region.

FIG. 6 is a flowchart of an example method for additively manufacturing an object from object model data specifying colors corresponding to dimensional compensations to be applied to respective object regions.

FIG. 7A is a diagram of an example system in which dimensional compensation software modifies object model data for an object to specify colors corresponding to dimensional compensations to be applied to respective object regions.

FIG. 7B is a diagram of an example non-transitory computer-readable data storage medium storing program code executed by a processor to realize the dimensional compensation software of FIG. 7A.

FIG. 8A is a diagram of an example system in which object modeling software generates object model data for an object that specifies colors corresponding to dimensional compensations to be applied to respective object regions.

FIG. 8B is a flowchart of an example method performed by a processor to realize the object modeling software of FIG. 8A.

FIG. 9 is a diagram of an example additive manufacturing apparatus to additively manufacture an object from object model data specifying colors corresponding to dimensional compensations to be applied to respective object regions.

### DETAILED DESCRIPTION

As noted in the background, additive manufacturing provides for physical generation of three-dimensional (3D) objects from computer-aided design (CAD) models. Object modeling software may be employed to create object model data for an object to be additively manufactured, where the object model data represents the geometry of the object. The object model data is then provided to an additive manufacturing apparatus (e.g., a 3D printer), which can generate instructions from the object model data that the apparatus then executes in order to physically generate the object.

In at least some types of additive manufacturing, including powder-bed fusion techniques such as MJF and SLS in which powdered build material is heated, melted, and cooled, dimensional inaccuracies can occur when physically generating an object from its object model data. For instance, MJF involves depositing build material in powder form on a layer-by-layer basis on a bed, or platform. After each build material layer is deposited, print agent, including fusing agent or both fusing agent and detailing agent, among other types of print agent, is selectively applied to the layer based on the object model data. Once the layers of build material have been deposited and print agent has been selectively applied to the layers, the build material layers may be subjected to an energy source to fuse the build material powder together to form the object. The energy source can be a generally non-focused energy source, such as a halogen lamp, an array of lamps, an array of light-emitting diodes (LEDs), and so on.

Dimensional inaccuracies, or deformations, can occur due to thermal process deviations during the additive manufacturing process in at least powder-bed fusion techniques. For example, different regions or features an object may exhibit different thermal behavior during additive manufacturing depending on their local geometries as well as the overall geometry of the object. Different types of build material and different types of print agent can also affect the thermal behavior of an object during additive manufacturing. Similarly, different areas of the fabrication chamber of an additive manufacturing apparatus may have different effects on thermal behavior, on a per-apparatus basis as well as on a per-apparatus type basis, such that where an object is manufactured in the chamber can affect its dimensional accuracy. Dimensional inaccuracies may also occur in types of additive manufacturing processes other than powder-bed fusion techniques, which may or may not be as a result of thermal behavior.

An additive manufacturing apparatus may therefore apply dimensional compensations to object model data when generating the instructions that are then executed in order to physically generate objects with greater dimensional accuracy. The dimensional compensations can be additive manufacturing apparatus specific to the particular apparatus that is being used and/or to its type (e.g., model) more generally. The dimensional compensations can be more general and global in nature in that they are not additive manufacturing apparatus specific at all. In both cases, the compensations are not specific to the particular object that is to be physically generated, and are further applied to the object model data as a whole in that different compensations are not individually specified for specific regions of a particular object.

Moreover, for a given object, certain regions may have dimensions that are more important than the dimensions of other regions. For example, an object may have an outer cylindrical shape and an inner cylindrical hole. A different object may be intended to precisely fit in the inner cylindrical hole of the object, and the object itself may be intended to precisely fit in the inner cylindrical hole of another different object. Therefore, the outer and inner diameters of these two object regions may be considered as critical dimensions, such that both dimensions may have to a specified accuracy for the object to be considered as dimensionally satisfactory when physically generated. If either or both dimensions are not sufficiently accurate, the object may not be satisfactory for its intended purpose, and discarded.

As noted above, the regions of the object may deform in different ways during additive manufacture. Moreover, applying the dimensional compensations that are not specific to the object itself, and that are not individually specified for each object region, can result in one region being dimensionally accurate and another not being dimensionally accurate. Adjusting the compensation so that the latter region becomes dimensionally accurate, though, can result in the former region no longer being dimensionally accurate when the object is additively manufactured.

One way to resolve this issue is to manually modify the actual geometry (e.g., the actual 3D model) of the object within the object model data so that subsequent application of dimensional compensations results in such regions being dimensionally accurate during additive manufacture. Such modification occurs before the additive manufacturing apparatus receives the object model data including the modified geometry.

For example, a user may modify the geometry of the object within object modeling software that is used to create the 3D model of the object. This software then generates the object model data that the additive manufacturing apparatus uses to physically generate the object. However, this process is laborious at best, and can unintentionally introduce new errors in the model that result in inaccurate additive manufacture of the object.

Techniques described herein ameliorate these and other issues. Different dimensional compensations can be specified within object model data for an object for respective individual regions of the object. When an additive manufacturing apparatus generates the instructions that are subsequently executed to physically generate the object, the specified compensation for a region is applied to just that region and not to other regions of the object. The region-specific dimensional compensations may be applied after more general dimensional compensations are applied for the object as a whole.

Moreover, the region-specific compensations can be specified for respective object regions within the object model data without (and instead of) having to modify the geometry of the object itself within the object model data. As a result, the unintentional introduction of new errors in the 3D model of the object can be avoided. The object model data, including the region-specific compensations, is provided to the additive manufacturing apparatus, which applies the compensations in the same way in which non-region-specific compensations are applied. However, the region-specific compensations are applied to just their respective regions as opposed to the object as a whole.

In the techniques described herein, dimensional compensations for specific regions of the object are specified by corresponding color values within the object model data of the object. Existing object model data file formats, for instance, may already provide for specification of different color values for different object regions. Leveraging this capability for a purpose for which it was not intended—the specification of different dimensional compensations for different regions of the object—permits existing file formats to be used without modification. This in turn means that in some implementations, existing object modeling software, for instance, can be employed without modification to specify dimensional compensations for respective object regions, since such modeling software is likely to be able to specify different colors for different object regions.

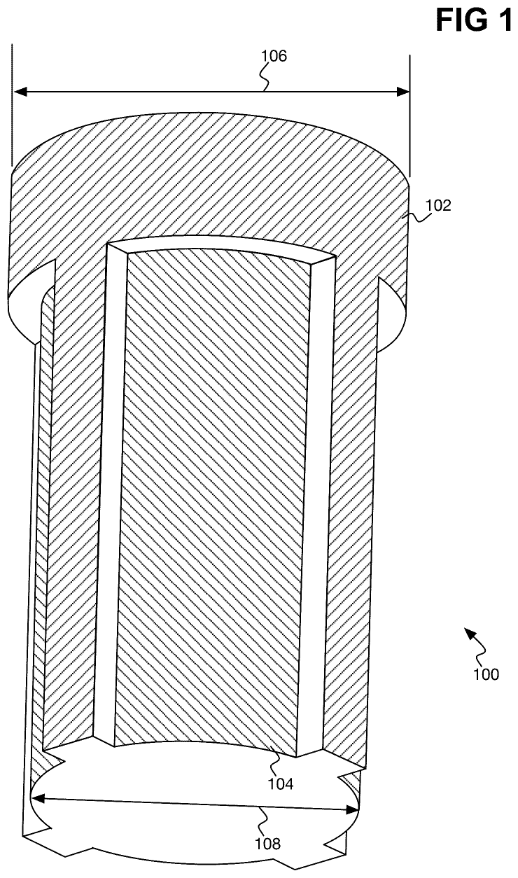

FIG. 1 shows an example object 100 having regions 102 and 104 to which different dimensional compensations may have to be applied to accurately physically generate the object 100 via additive manufacturing. The region 102 may be or include the outer cylindrical surface of the object 100, whereas the region 104 may be or include the inner cylindrical surface of the object 100. The regions 102 and 104 have respective diameters 106 and 108 that may be considered critical dimensions that have to have a desired or specified level of accuracy when the object 100 is additively manufactured for the object 100 to be considered satisfactory.

The regions 102 and 104 may, such as in the case of power-bed fusion additive manufacturing techniques, have different thermal behavior during additive manufacture of the object 100. If the same (global) dimensional compensation is applied to both regions 102 and 104 (i.e., when applied to the object 100 as a whole), the diameter 106 of the region 102 may be as accurate as desired (i.e., it may not satisfy a specified accuracy threshold) during subsequent additive manufacture of the object 100, whereas the diameter 108 of the region 104 may not. Adjusting this global compensation so that the diameter 108 then has satisfactory accuracy, however, may result in the diameter 106 no longer having satisfactory accuracy. Therefore, object model data for the object 100 can specify different dimensional compensations for the regions 102 and 104. However, the object model data for the object 100 can specify different dimensional compensations for the regions 102 and 104 regardless of whether dimensional deformation is a result of thermal behavior or not.

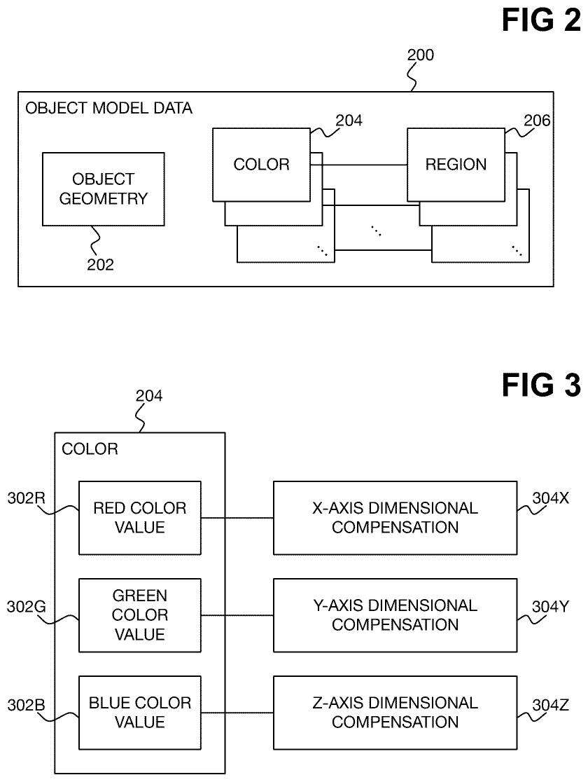

FIG. 2 shows example object model data 200 for an object, such as the object 100. The object model data 200 can be a standard file format, such as the 3D Manufacturing Format (3MF), and may not be specific to a particular type, model, or manufacturer of additive manufacturing apparatus, nor to a particular type of object modeling software. The object model data 200 in such a format represents the object geometry 202 that the object is to have when additively manufactured, which can also be referred to as the 3D model of the object.

The object model data 200 is in a file format that permits the object model data 200 to specify colors 204 for respective regions 206 of the object having the object geometry 202. The file format may provide for such specification of colors 204 for object regions 206 so that the regions 206 have the colors 204 when the object is physically generated via additive manufacturing. However, the specification of the colors 204 for the object regions 206 is used herein to instead or additionally indicate the dimensional compensations that are to be respectively applied to just the regions 206. The dimensional compensations may be axes-based, and may be specified separately and applied independently in the axes. For example, when a Cartesian coordinate system is employed, dimensional compensations may be separately specified and independently applied in each of the x-, y-, and z-axes.

The regions 206 may be respective surfaces of the object having the geometry 202, or may be other types of regions of the object, such as individually specified sub-geometries of the geometry 202, individually specified features of the object, and so on. When the regions 206 are surfaces of the object, the dimensional compensations corresponding to the respective colors for the regions 206 may be applied to these surfaces. When the regions 206 are other types of regions, the dimensional compensations to be applied to the entirety of the regions 206, or just to their surfaces.

FIG. 3 shows an example color 204 for an object region 206 as may be specified within the object model data 200 along with the geometry 202 of the object to be additively manufactured. In the example, the color 204 is defined by red, green, and blue color values 302R, 302G, and 302B. The color values 302R, 302G, and 302B may be intended in the file format of the object model data 200 to define, per the red-green-blue (RGB) color space or model, the color 204 that the object region 206 is to have when additively manufactured by color values for the red, green, and blue channels constituting that color 204.

However, in the example, the color values 302R, 302G, and 302B instead or additionally indicate dimensional compensations 304X, 304Y, and 304Z along the x-, y-, and z-axes, respectively, for just the region 206 in question. That is, the red color value 302R specifies and corresponds to the compensation 304X to be applied to the region 206 along the x-axis; the green color value 302G specifies and corresponds to the compensation 304Y to be applied to the region 206 along the y-axis; and the blue color value 302B specifies and corresponds to the compensation 304Z to be applied to the region 206 along the z-axis.

The color values 302R, 302G, and 302B for the region 206 may be stored in the object model data 200 in the specific location that the file format of the object model data 200 intends for designating the color 204 that the region 206 is to have when additively manufactured. Stated another way, the color values 302R, 302G, and 302B are stored in the intended location in the object model data 200 as specified by the file format for designating the color 204. In the example, however, the color values 302R, 302G, and 302B also or instead are used to indicate dimensional compensations 304X, 304Y, and 304Z for the object region 206, as noted above.

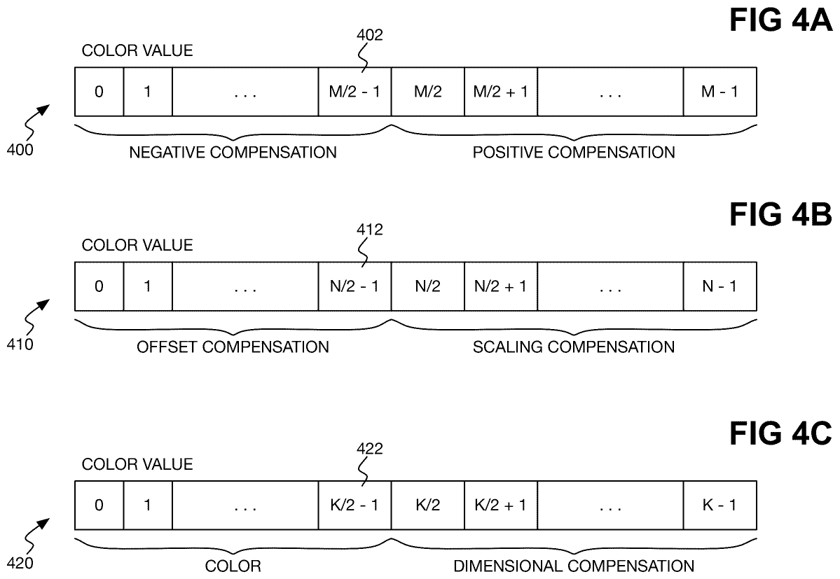

FIG. 4A shows an example as to how a color value 400 can be used to indicate a negative dimensional compensation or a positive dimensional compensation. While the color 204 for the region 206 may be represented as a number of color values corresponding to the color channels of the employed color space (e.g., red, green, and blue color values in the case of the RGB color space), the color value 400 represents any such color value. The color value 400 may be the color value 302R, 302G, or 302B for an object region 206, for instance. Therefore, when the color value 400 is the color value 302R, the dimensional compensation represented by the color value 400 is the dimensional compensation 304X along the x-axis. Similarly, when the color value 400 is the color value 302G, the dimensional compensation represented by the color value 400 is the dimensional compensation 304Y along the y-axis. When the color value 400 is the color value 302B, the dimensional compensation represented by the color value 400 is the dimensional compensation 304Z along the z-axis. This means that for the object region 206, there will be three color values 400 corresponding to the color values 302R, 302G, and 302B.

The color value 400 has M bits 402. The lower M/2 bits 402 (i.e., bits 0, 1, . . . , M/2−1) are used to indicate a negative compensation, whereas the upper M/2 bits 402 (i.e., bits M/2, M/2+1, . . . , M−1) are used to indicate a positive compensation (and, more generally, a non-negative compensation). The lower M/2 bits 402 may be referred to as a first portion of the color value 400, and the upper M/2 bits 402 may be referred to as a second portion of the color value 400.

For example, when the dimensional compensation is a negative compensation, the upper M/2 bits 402 are each set to zero, and the lower M/2 bits 402 encode a value corresponding to the magnitude of the compensation. Similarly, when the dimensional compensation is a positive compensation, the lower M/2 bits 402 are set to zero, and the upper M/2 bits encode a value corresponding to the magnitude of the compensation. This means that for a color value 400 having M bits 402, up to 2\hat{ }(M/2) different negative compensations can be encoded, and likewise up to 2\hat{ }(M/2) different non-negative compensations can be encoded.

Other techniques may also be used to encode a dimensional compensation that may be positive or negative within the M bits 402 of the color value 400, such as where the most-significant bit 402 represents the sign, and the least significant M−1 bits 402 represent magnitude. The dimensional compensation may also be encoded in the color value 400 in a variable-length manner to improve storage efficiency, so that the number of bits used to store the color value 400 is not static but instead varies in correspondence with magnitude.

FIG. 4B shows an example as to how a color value 410 can be used to indicate both an offset dimensional compensation and a scaling dimensional compensation. An offset dimensional compensation means that the object region 206 in question is offset along the axis in question by an offset value specified by the encoded value. For example, the coordinate of the edge or surface of the region 206 is moved, or offset, along the axis in a positive or negative direction as specified by the encoded value. That is, a surface voxel may be offset by a number of voxels (e.g., ten voxels) corresponding to the encoded value.

A scaling dimensional compensation, by comparison, means that the size of the object region 206 in question is scaled along the axis in question by a scaling factor specified by the encoded value. For example, the distance between the edges of the region 206 along the axis is adjusted, or scaled, by a positive or negative factor as specified by the encoded value. That is, the region 206 may be scaled by a percentage (e.g., 0.5%) corresponding to the encoded value. Offset compensation can be liked to addition or subtraction, whereas scaling compensation can be liked to multiplication or division.

The color value 410 has N bits 412. The lower N/2 bits 412 (i.e., bits 0, 1, . . . , N/2−1) are used to indicate an offset compensation, whereas the upper N/2 bits 412 (i.e., bits N/2, N/2+1, . . . , N−1) are used to indicate a scaling compensation. The lower N/2 bits 412 may indicate the offset compensation negatively or positively, and likewise the upper N/2 bits 412 may indicate the scaling compensation negatively or positively. In this case, the lower N/2 bits 412 may encode the offset compensation per FIG. 4A, and likewise the upper N/2 bits 412 may encode the scaling compensation per FIG. 4A, which means that N=2*M. The lower N/2 bits 412 may be referred to as a first portion of the color value 410, and the upper N/2 bits 412 may be referred to as a second portion of the color value 410.

FIG. 4C shows an example as to how a color value 420 can be used to indicate both color and dimensional compensation. The color value 420 has K bits 422. The lower K/2 bits 422 (i.e., bits 0, 1, . . . , K/2−1) are used to indicate the color that the object region 206 in question is to have when additively manufactured, whereas the upper K/2 bits 422 (i.e., bits K/2, K/2+1, . . . , K−1) are used to indicate the dimensional compensation to be applied to the region 206 when additively manufactured. The lower K/2 bits 422 may be referred to as a first portion of the color value 420, and the upper K/2 bits 422 may be referred to as a second portion of the color value 420.

In one implementation, each of the color values 302R, 302G, and 302B of FIG. 3 may be implemented as the color value 420. Therefore, each of the color values 302R, 302G, and 302B has K bits 422. The lower K/2 bits 422 are used to encode the corresponding actual red, green, or blue channel value of the color of the object region 206. The upper K/2 bits 422 are used to encode the corresponding x-axis, y-axis, or z-axis dimensional compensation 304X, 304Y, or 304Z for the object region 206.

Furthermore, in this case, the upper K/2 bits 422 for a given color value 302R, 302G, or 302B can itself include both an offset compensation and a scaling compensation for the x-axis, y-axis, or z-axis corresponding to that color value 302R, 302G, or 302B, per FIG. 4B, such that N=K/2. Additionally, as noted above, these offset and scaling compensations can themselves each be negative or positive, per FIG. 4A, such that N=2*M and therefore M=K/4.

In another implementation, the lower K/2 bits 422 may be used to encode the actual color 204 of the region 206, with the upper K/2 bits 422 used to encode the dimensional compensation for the region 206. For example, the lower K/2 bits 422 may include the red, green, and blue channel values of the actual color 204 of the region 206, whereas the upper K/2 bits 422 include the dimensional compensations 304X, 304Y, and 304Z for the region 206 along the x-, y-, and z-axes, respectively.

Here, too, the dimensional compensation along each axis can include both an offset compensation and a scaling compensation, per FIG. 4B. Since in this case, the upper K/2 bits 422 encode the dimensional compensations for all three x-, y-, and z-axes, this means that 3N=K/2 (i.e., K=6N and N=K/6). Additionally, as noted above, the offset and scaling compensations for each of the x-, y-, and z-axes may themselves be negative or positive, per FIG. 4A, such that N=2*M, and therefore 6M=K/2 (i.e., K=12M and M=K/12).

The dimensional compensation and the actual color of a region 206 may be encoded in other ways as well. For example, in the red-green-blue-alpha (RGBA) color space, the color value for the alpha color channel specifies the opacity of the color defined by the red, green, and blue color values. In this case, the actual color of a region may still be encoded by the red, green, and blue color values, and the dimensional compensation region may be encoded within the alpha color value. For instance, if the alpha color value is R bits in length, the first R/3 bits may specify the x-axis dimensional compensation, the second R/3 bits may specify the y-axis dimensional compensation, and the third R/3 bits may specify the z-axis dimensional compensation.

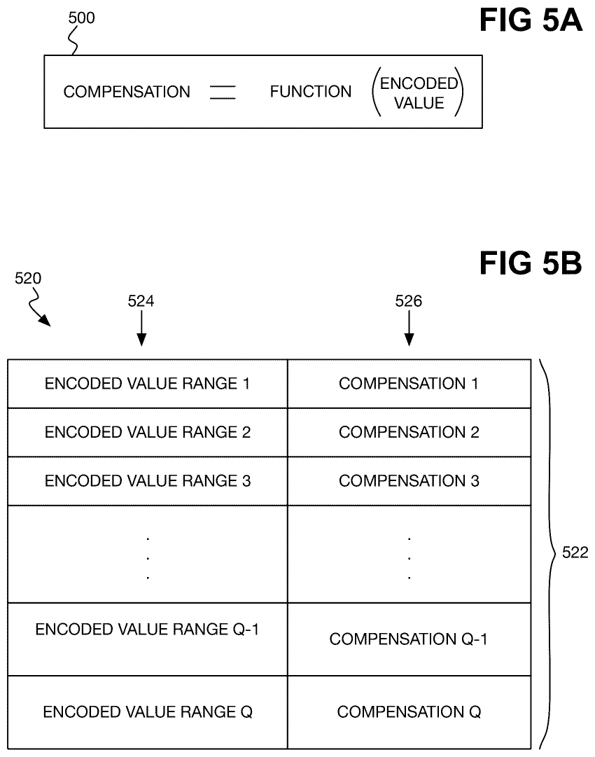

FIG. 5A shows an example function 500 for determining the dimensional compensation to apply to an object region 206 from the color value specified for that region 206 within the object model data 200. The dimensional compensation is specifically computed as a function 500 of the value encoded by the color value. For example, if the color value is L bits in length, the encoded value may be an unsigned integer between the 0 and 2\hat{ }(L−1).

However, in the case of FIG. 4A, the encoded value to which the function 500 is applied may be the magnitude denoted by the lower or upper M/2 bits 402. For a given magnitude, the dimensional compensation computed by the function 500 is therefore negative when specified by the lower M/2 bits 422 and positive when specified by the upper M/2 bits 422.

In the case of FIG. 4B, the encoded value specified by the lower N/2 bits 412 is used in one function 500 to determine the offset compensation, and the encoded value specified by the upper N/2 bits 412 is used in the same or different function 500 to determine the scaling compensation. In the case of FIG. 4C, the encoded value to which the function 500 is applied is specified by the upper K/2 bits 422.

FIG. 5B shows an example lookup table 520 for determining the dimensional compensation to apply to an object region 206 from the color value specified for that region 206 within the object model data 200. The lookup table 520 has Q number of entries 522 that each specify a dimensional compensation 526 for a range 524 of encoded values. The dimensional compensation for the region 206 is specifically determined as the compensation 526 of the entry 522 having the range 524 which encompasses the value encoded by the color value for that region 206. If the encoded value falls within the range Q−1 of the second to last entry 522 in the table 520, then the dimensional compensation is retrieved as the compensation Q−1 of that entry 522, for instance.

For example, if the color value is L bits in length, the encoded value that is looked up in the lookup table 520 may be an unsigned integer between the 0 and 2\hat{ }(L−1). In the case of FIG. 4A, the encoded value that is looked up in the table 520 may be the magnitude denoted by the lower or upper M/2 bits 402. In the case of FIG. 4B, the encoded value specified by the lower N/2 bits 412 is looked up in one lookup table 520 to determine the offset compensation, and the encoded value specified by the upper N/2 bits 412 is looked up in a different table 520 to determine the scaling compensation. In the case of FIG. 4C, the encoded value specified by the upper K/2 bits 422 is looked up in the table 520.

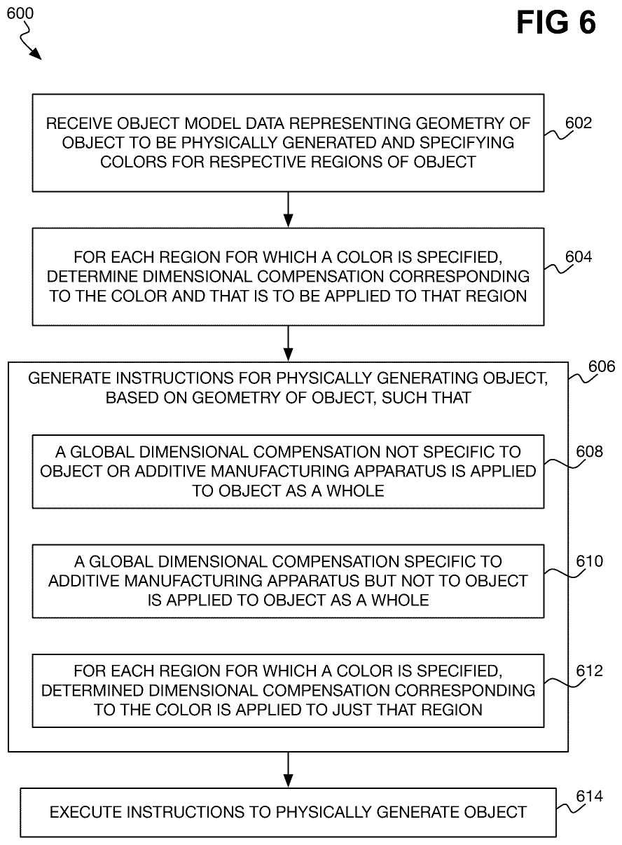

FIG. 6 shows an example method 600 for additively manufacturing an object from object model data 200 specifying colors 204 corresponding to dimensional compensations to be applied to respective object regions 206. The method 600 is performed by an additive manufacturing apparatus, such as a 3D printer to generate the object. For example, in the case of MJF, layers of build material powder are deposited, where after each layer is deposited, print agent is selectively applied. Once the layers have been deposited, the powder is subjected to energy to selectively fuse it together to form the object in correspondence with where fusing agent has been applied.

The method 600 begins with the additive manufacturing apparatus receiving object model data 200 that represents the geometry 202 of an object and that specifies colors 204 for respective regions 206 of the object (602). For example, each color 204 may, per FIG. 3, be specified as a set of color values 302R, 302G, and 302B that are each specified as color value 400, 410, or 420 per FIG. 4A, 4B, or 4C.

The method 600 includes determining, for each region 206 for which a color 204 is specified within the object model data 200, a dimensional compensation corresponding to that color 204 and which is to be applied to just that region 206 (604). Note that not all of the object regions 206 may have colors 204 specified in the object model data 200. The dimensional compensation for a region 206 for which a color 204 is specified can include either or both of an offset compensation value and a scaling compensation factor, and may be specified for each axis.

Determining the dimensional compensation corresponding to a color 204 for a region 206 can be achieved by identifying one or more color values representing or defining the color 204 in the object model data 200, such as the color values 302R, 302G, and 302B of FIG. 3. From each such color value, an encoded value corresponding to the dimensional compensation is extracted, such as per FIGS. 4A, 4B, and/or 4C. Finally, the dimensional compensation can be determined from the encoded value per FIG. 5A or 5B.

The method 600 includes generating instructions for physically generating the object when executed by the additive manufacturing apparatus (606). Generation of the instructions can involve applying global dimensional compensations 608 and 610 to the object geometry 202 within the received object model data 200, before then applying region-specific dimensional compensations 612 to just their respective regions 206. The region-specific dimensional compensations 612 are those that have been determined in (604).

Either or both global dimensional compensations 608 and 610 can therefore be applied to the object as a whole (i.e., to the object geometry 202 as a whole) before the region-specific dimensional compensations 612 are applied to just their respective object regions 206. The global compensation 608 is specific to the additive manufacturing apparatus (such as to the individual apparatus in particular, and/or to the type of the apparatus).

The global dimensional compensation 608 may be part of a dimensional profile for the additive manufacturing apparatus or its type (e.g., model), for instance, and stored in the apparatus itself. The global compensation 608 may specify an offset value and/or a scaling factor as a function of the location in the build chamber where the object is to be manufactured, as one example. The global compensation 608 is thus not specific to the object represented by the geometry 202 within the object model data 200.

The global dimensional compensation 610 may also specify an offset value and/or a scaling factor, but as a function of each voxel of the object within the object geometry 202 relative to the other voxels. For instance, the global compensation 610 may be based on whether a voxel is part of an internal or external feature, the type of feature (e.g., lattice, hole, etc.) that the voxel is a part of, the shape of the feature that the voxel is a part of, and so on.

In comparison to the global dimensional compensation 608, the global dimensional compensation 610 may not be specific to the additive manufacturing apparatus or its type. The global compensation 610 is like the global compensation 610, however, in that it also is not specific to the object represented by the geometry 202 within the object model data 200. For instance, while the global compensation 610 may specify a function that provides an offset value and/or a scaling factor for each voxel of the object, the function itself is not specific to the object, nor to any individual region 206 of the object.

Once the global dimensional compensations 608 and/or 610 have been applied to the object, the processing includes applying, for each region 206 for which a color 204 is specified within the object model data 200, the dimensional compensation 612 corresponding to that color 204 that has been determined in (604). The dimensional compensation 612 for a given region 206 is applied just to that region 206, and not to any other region 206 of the object. The dimensional compensation 612 is thus not a global compensation because it is not applied to the object as a whole. The global dimensional compensations 608 and/or 610, though, are applied to the region 206 when present.

The application of the dimensional compensations 608, 610, and 612 thus effectively modifies the object geometry 202 within the received object model data 200, by applying offsets to and scaling the geometry 202 in order to dimensionally compensate the geometry 202 for thermal effects that occur during the additive manufacturing process. The remainder of the instruction generation process in (606) includes therefore specifying the locations on each layer where print agent is to be applied, including potentially the amount and/or type of print agent, so that the object is accurately formed when fusing occurs.

As one example, the instructions can specify that the layers of build material each receive fusing agent at locations in correspondence with the object geometry 202 as modified via application of the dimensional compensations 608, 610, and 612. A location on a layer corresponding to a voxel in the modified object geometry 202 may thus receive fusing agent, whereas a location that does not correspond to a voxel does not. The method 600 culminates with the actual execution of the generated instructions in order to physical generate the object via additive manufacturing (614).

It is noted that the global, or general, dimensional compensations 608 and 610 are examples, and any other types of global dimensional compensations can also be applied to the object as a whole, in addition to and/or in lieu of the compensations 608 and/or 610. Furthermore, the order in which the global dimensional compensations (regardless of type) are applied, relative to one another as well as relative to the region-specific dimensional compensations 612, can differ from that depicted in FIG. 6. For example, all the global compensations may be applied before the region-specific compensations 612 as depicted in FIG. 6, or after the compensations 612. As an additional example, some global compensations may be applied before the region-specific compensations 612, and other global compensations may be applied after the compensations 612.

It is also noted the region-specific dimensional compensations 612 specified in the object model data 200 may assume or specify that a given orientation of the object in 3D space. That is, the geometry 202 for the object may have a particular orientation in 3D space. In the case where the dimensional compensations 612 along the x-, y-, and z-axes, the additive manufacturing apparatus may be prohibited from rotating the object when printing the object. That is, the object is printed at the assumed or specified orientation within the object model data 200.

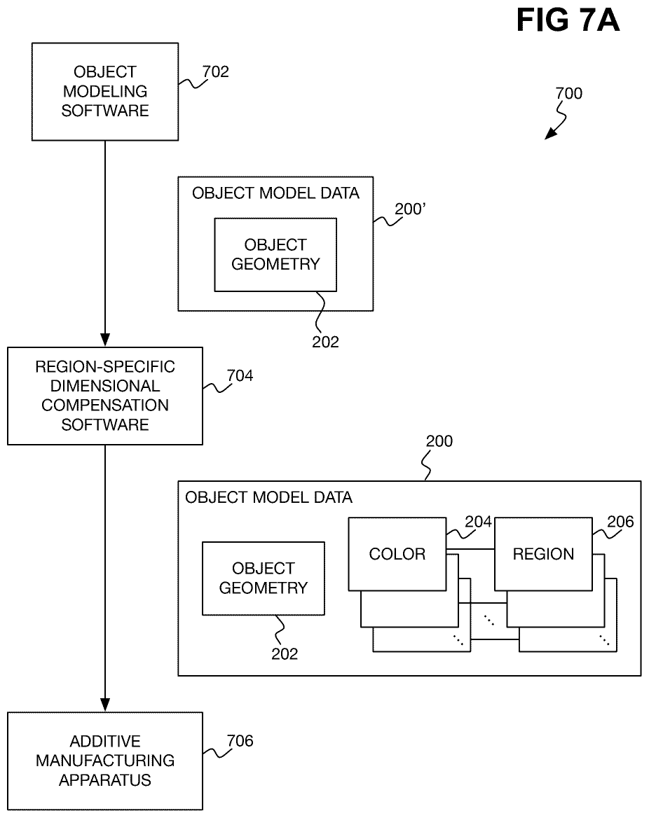

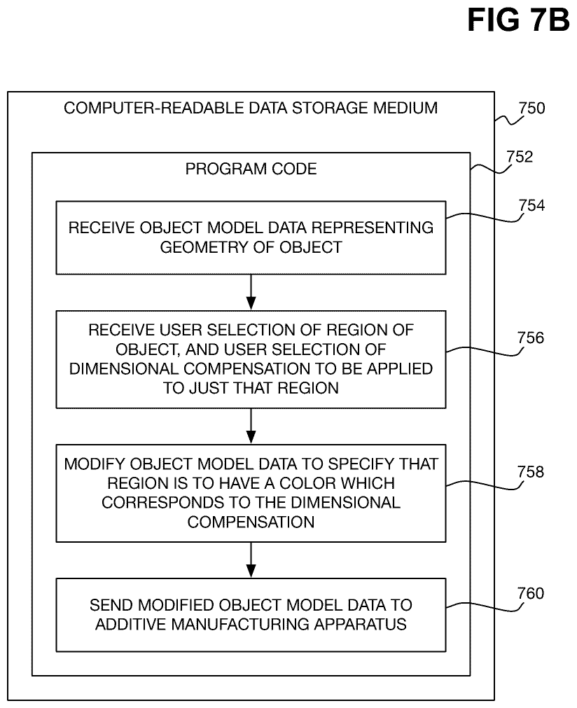

FIG. 7A shows an example system 700 including object modeling software 702, region-specific dimensional compensation software 704, and an additive manufacturing apparatus 706. The object modeling software 702 and the dimensional compensation software 704 may be run on the same computing device or on different computing devices. The object modeling software 702 is used by a user to create the object geometry 202 for an object.

The object modeling software 702 thus generates and outputs object model data 200′, such as in the 3MF or another standard format, that represents the geometry 202 specified or created by the user for the object. The object model data 200′ does not, however, specify colors 204 corresponding to the dimensional compensations to be applied to respective object regions 206.

For instance, the object modeling software 702 may not have the capability to specify colors 204 that specifically correspond to the dimensional compensations that are to be applied to respective regions 206. This means that object modeling software 702 can be used in the system 700 without having to be modified or designed to have this capability. Stated another way, the techniques described herein do not require purpose-built object modeling software 702 in this respect.

The region-specific dimensional compensation software 704 receives the object model data 200′ as input. The dimensional compensation software 704 modifies the object model data 200′ to specify colors 204 corresponding to the dimensional compensations to be applied to respective object regions 206. Which regions 206 are to have region-specific dimensional compensations applied to them, and the particular dimensional compensation for each region 206 may be selected by a user. The user using the dimensional compensation software 704 may be different than the user who created the geometry 202 using the object modeling software 702. In another implementation, which regions 206 are to have region-specific dimensional compensations, and the particular compensation for each region 206, may be determined in an automated manner.

The region-specific dimensional compensation software 704 generates and outputs the object model data 200 that includes the geometry 202 specified by the input object model data 200′, but which also specifies colors 204 corresponding to the dimensional compensations for the object regions 206. The software 704 does not, however, modify the object geometry 202.

That is, the geometry 202 of the object represented by the object model data 200 output by the dimensional compensation software 704 is the same geometry 202 included in the object model data 200′ that was input into the software 704. The application of the dimensional compensations in correspondence with the colors 204 specified for respective object regions 206 instead occurs in the additive manufacturing apparatus 706.

The additive manufacturing apparatus 706 therefore receives the object model data 200 output by the region-specific dimensional compensation software 704, and physically generates the object having the geometry 202 represented by the object model data 200. The apparatus 706 can perform the method 600 of FIG. 6, for instance. The apparatus 706 may thus apply global dimensional compensations 608 and 610 to the object geometry 202 before applying the region-specific compensations 612 to their respective regions 206. Upon modification of the object geometry 202, the apparatus 706 determines which locations of which build material layers are to receive print agent, and then follows these instructions to physically generate the object.

FIG. 7B shows an example non-transitory computer-readable data storage medium 750 storing program code 752 executable by a processor of a computing device to realize the region-specific dimensional compensation software 704. The processing performed by the processor when executing the program code 752 includes receiving the object model data 200′ (754). The object model data 200′ represents the geometry 202 of the object to be physically generated via additive manufacturing.

The processing includes receiving user selection of a region 206 of the object, and user selection of a dimensional compensation to be applied to just that region 206 (756). For example, the dimensional compensation software 704 may render and display a 3D model corresponding to the geometry 202, and permit the user to rotate and zoom in and out of the object. The user can then select a region 206, and specify the dimensional compensation to be applied to just that region 206.

The processing includes modifying the object model data 200′ to specify a color 204 for the region 206 that corresponds to the dimensional compensation to be applied to just that region 206 (758). The dimensional compensation software 704 can determine an encoded value for the specified dimensional compensation using the inverse function to the function 500 of FIG. 5A, or by using the lookup table 520 of FIG. 5B. The encoded value can then be used as or included in the color value for the region 206, per FIGS. 3, 4A, 4B, and/or 4C, and there may be multiple color values defining the color 204 of the region 206 per FIG. 3.

Modifying the object model data 200′ yields the object model data 200, which specifies the color 204 for the region 206 in addition to including the object geometry 202. The processing performed via execution of the program code 752 does not modify the geometry 202 of the object. Rather, the dimensional compensation for the region 206 is reflected in the object model data 200 in that the color 204 included in the object model data 200 corresponds to the dimensional compensation.

The processing that has been described as to user selection of a region 206 and user selection of a dimensional compensation to be applied to just that region 206 in (756), and the modification of the object model data 200′ to specify that the region 206 is to have a color 204 corresponding to this dimensional compensation in (758), can be repeated for multiple regions 206.

For example, a user may select a first object region 206 and a first dimensional compensation for the first region 206, such that the modified object model data 200 includes a first color 204 for the first region 206 corresponding to the first dimensional compensation. A user may then select a second object region 206 and a second dimensional compensation for the second region 206, such that the modified object model data 200 includes a second color 204 for the second region 206 corresponding to the second dimensional compensation.

Once the object model data 200′ has been modified as the object model data 200, the processing can include sending the object model data 200 to the additive manufacturing apparatus 706 for physically generating the object from the object model data 200 (760). As has been described, the apparatus 706 determines the dimensional compensations corresponding to the specified colors 204, and applies the determined compensations to their respective regions 206 in generating instructions that are then executed to additively manufacture the object.

The example of FIGS. 7A and 7B that has been described thus pertains to the situation where the object modeling software 702 does not have to be modified, and may be unaware that the colors 204 for regions 206 are being used to correspond to dimensional compensations to be applied to those regions 206. Rather, in this example, separate dimensional compensation software 704 is employed to input the object model data 200′ generated by the object modeling software 702, and modify the object model data 200′ to include colors 204 corresponding to the dimensional compensations to be applied to respective regions 206.

However, the object modeling software 702 may itself be able to generate the object model data 200 that includes colors 204 for specific regions 206, but may not have the ability to determine which color 204 to use for a given region 206 in correspondence with the dimensional compensation to be applied to that region 206. In this case, the dimensional compensation software 704 may just be able to output the color that corresponds to a given dimensional compensation. Therefore, the user may use the object modeling software 702 and the dimensional compensation software 704 side-by-side. For instance, where for a region 206 to which a dimensional compensation is to be applied to a given region 206, the user manually inputs the compensation into the dimensional compensation software 704, which outputs the color 204 corresponding to that compensation.

The user then manually specifies that color 204 for the region 206 in the object modeling software 702. The object modeling software 702 is still unaware that the color 204 corresponds to the dimensional compensation to be applied to the region 206 (i.e., the software 702 may presume that the object is to be additively manufactured to have the specified color 204 for that region 206). However, the modeling software 702 in this case generates the object model data 200 including such colors 204 for respective regions 206 corresponding to the compensations to be applied to the regions 206, as opposed to generating the object model data 200′ without specification of the colors 204.

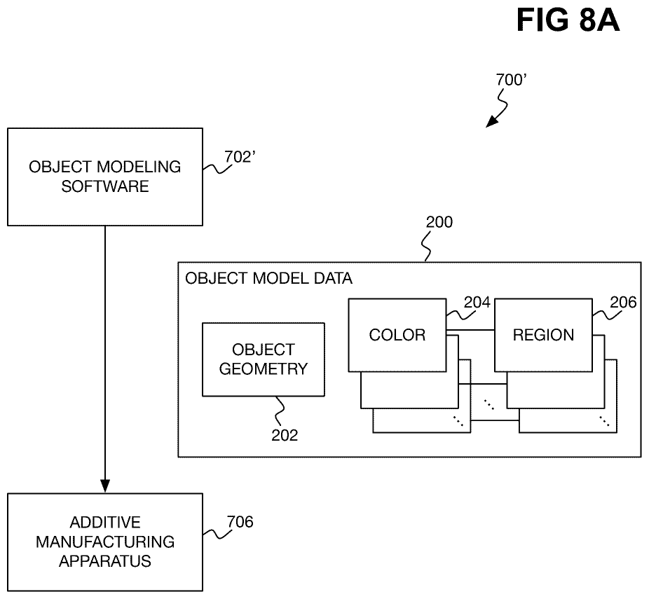

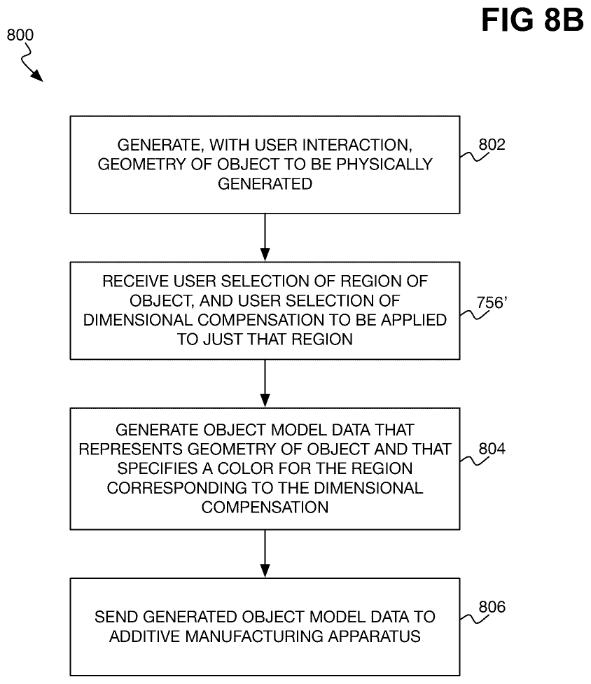

FIG. 8A shows an example system 700′ including object modeling software 702′ and the additive manufacturing apparatus 706, but which may not include the region-specific dimensional compensation software 704 of FIG. 7A. Furthermore, unlike the object modeling software 702 of FIG. 7A that may not have the capability to identify which colors 204 correspond to which dimensional compensations to be applied to respective object regions 206, the object modeling software 702′ of FIG. 7B has this capability. The modeling software 702′ may be a modified or updated version of the modeling software 702 in this respect, for instance.

Because the object modeling software 702′ is able to generate the object model data 200 that specifies colors 204 corresponding to the dimensional compensations to be applied to respective regions 206, in addition to representing the object geometry as the object modeling software 702 already does, the region-specific dimensional compensation software 704 of FIG. 7A may not be needed. That is, the dimensional compensation software 704 is present in FIG. 7A to modify the object model data 200′ received from the object modeling software 702 to specify colors 204 corresponding to dimensional compensations for respective regions 206. By comparison, the object modeling software 702′ already has this capability, such that the dimensional compensation software 704 may not be necessary.

The object modeling software 702′ generates object model data 200 to represent the geometry 202 of an object as specified by the user and as to be additively manufactured by the additive manufacturing apparatus 706. The modeling software 702′ further generates the object model data 200 to specify colors 204 that correspond to user-selected dimensional compensations to be applied by the apparatus 706 to respective user-selected object regions 206 to more accurately physically generate the object. Upon receiving the object model data 200 output by the software 702′, the additive manufacturing apparatus 706 can therefore physically generate the object with improved dimensionally accuracy, as has been described.

FIG. 8B shows an example method 800 performed by a processor of a computing device to realize the object modeling software 702′. The method 800 includes generating, with user interaction, the geometry 202 of an object to be physically generated via additive manufacturing (802). For example, the object modeling software may be CAD software that provides for the generation of such 3D object models.

The method 800 includes receiving user selection of a region 206 of the object, and user selection of a dimensional compensation to be applied to just that region 206 (756′), as has been described in relation to (756) in FIG. 7B. The method 800 includes generating object model data 200 to include the object geometry 202, as well as to specify a color 204 for the region 206 corresponding to the dimensional compensation to be applied to just that region 206 (804). The color 204 can be specified as one or more color values, as has been described in relation to (758) in FIG. 7B.

Also as in FIG. 7B, the method 800 of FIG. 8B can receive user selection of multiple regions 206 of the object and respective dimensional compensations to be applied to the regions 206. As such, the object model data 200 can specify different colors 204 that correspond to different compensations to be applied to different regions 206, respectively. Once the object model data 200 has been generated, the method 800 can include then sending the object model data 200 to the additive manufacturing apparatus 706 for physical generating the object from the object model data 200 (806), as has been described.

It is noted that the magnitude of the dimensional compensation may be small as compared to the size of the color value defining the color 204 for a region 206. For example, the color value is 32 bits and may correspond to just an offset dimensional compensation along the x-axis. In this case, even a relative largely offset compensation of 32 voxels represents just five bits of difference in color (i.e., 2\hat{ }5=32).

A user, however, may not be able to detect such small color differences for different regions 206 of the object. Therefore, the object modeling software 702′ (in FIGS. 8A and 8B) or the dimensional compensation software 704 (in FIGS. 7A and 7B) may exaggerate the color differences in different regions 206 so that they are visually distinguishable, or may indicate the color differences in another way so that they are visually distinguishable.

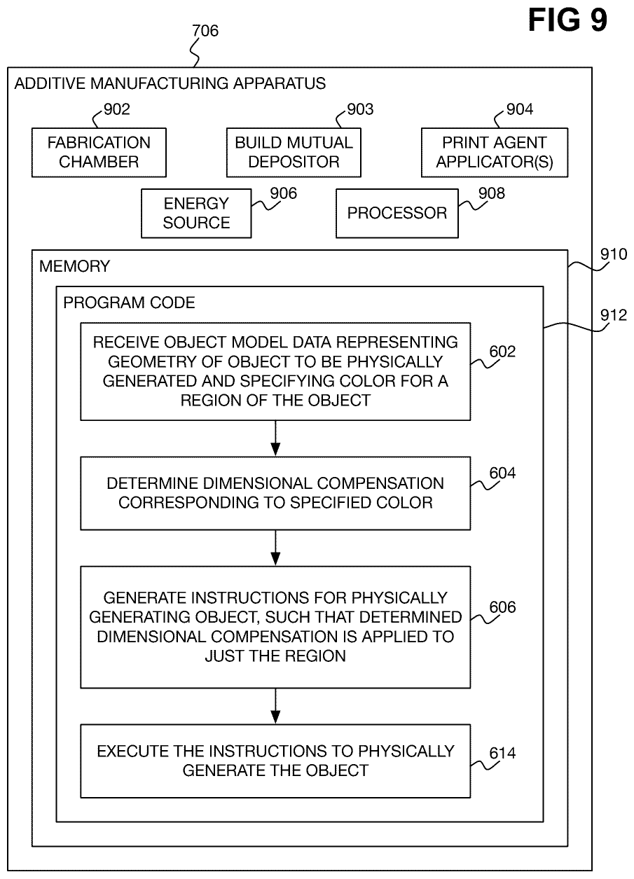

FIG. 9 shows an example of the additive manufacturing apparatus 706. The apparatus 706 may also be referred to as a 3D printer, and can physically generate an object from object model data 200 via additive manufacturing. As one example, the apparatus 706 may additively manufacture the object via MJF. The apparatus 706 includes a processor 908 and memory 910 storing program code 912. The additive manufacturing apparatus 706 also includes other components, depending on the additive manufacturing technique it employs to generate an object from object model data 200.

For example, in the case of MJF, the apparatus 706 can include a fabrication chamber 902, a build material depositor 903, one or multiple print agent applicators 904, and an energy source 906, among other components. The build material depositor 903, which may also be referred to as a build material deposition mechanism and which can include rollers, hoppers, and so on, deposits layers of build material in powder form in the fabrication chamber 902. The first layer is deposited on a bed of the chamber 902 and subsequent layers are each deposited over the immediately prior layer.

After each layer is deposited, the print agent applicators 904, which may be referred to as printheads, selectively apply print agent, such as just fusing agent or both fusing agent and detailing agent, on the layer in correspondence with the object geometry 202 as has been dimensionally compensated. Once all the layers have been deposited, the energy source 906, which may be referred to as a fuser and which may be or may include a heater, applies substantially uniform energy to the build material layers to selectively fuse the build material powder to form the object.

The processor 908 executes the program code 912 to perform processing. The processing includes, per FIG. 6, receiving object model data 200 representing the geometry 202 of an object to be physically generated and that specifies the color 204 for a region 206 of the object (602). The processing includes determining a dimensional compensation corresponding to the specified color 204 (604), and generating instructions for physically generating the object such that the determined dimensional compensation is applied to just its respective region 206 (606). The processing includes then executing the instructions to physically generate the object (614).

Techniques have been described for specifying dimensional compensations to be applied to just respective objection regions by the usage of colors for the regions within the object model data that represents the geometry of the object to be additively manufactured. An additive manufacturing apparatus therefore may not generate the object so that an object region has the color specified for the region in the object model data. Rather, the color is employed to specify the dimensional compensation to be applied to the object region. That is, the specification of the color is employed to notify the additive manufacturing apparatus of the dimensional compensation to be applied to just that region.

We claim:

1. An additive manufacturing apparatus comprising:
a processor; and
a memory storing program code executable by a processor to:
receive object model data representing a geometry of an object and specifying a color value for a region of the object, the object to be physically generated via additive manufacturing by the additive manufacturing apparatus;
determine a dimensional compensation corresponding to the color value specified for the region of the object;
generate instructions for physically generating the object, based on the geometry of the object and the determined dimensional compensation, such that the dimensional compensation is applied to just the region of the object for which the color has been specified; and
execute the instructions to physically generate the object.

2. The additive manufacturing apparatus of claim 1, wherein the color value is employed just to specify the dimensional compensation to be applied to the region of the object.

3. The additive manufacturing apparatus of claim 1, wherein the color value comprises a plurality of color component values corresponding to different color components of a color represented by the color value,
and wherein each color component value specifies the dimensional compensation to be applied to the region of the object along a corresponding directional axis.

4. The additive manufacturing apparatus of claim 1, wherein the dimensional compensation comprises either or both of an offset dimensional compensation and a scaling dimensional compensation.

5. The additive manufacturing apparatus of claim 1, wherein the color value comprises a first portion and a second portion,
wherein the first portion specifies an offset dimensional compensation to be applied to the region, and the second portion specifies a scaling dimensional compensation to be applied to the region.

6. The additive manufacturing apparatus of claim 1, wherein the instructions are further generated such that an additive manufacturing apparatus-specific dimensional compensation that is not specific to the object is applied to the object as a whole before or after the dimensional compensation is applied to just the region for which the color value has been specified.

7. The additive manufacturing apparatus of claim 1, wherein the instructions are further generated such that a global dimensional compensation that is not specific to the object or to the additive manufacturing apparatus is applied to the object as a whole before or after the dimensional compensation is applied to just the region for which the color value has been specified.

8. The additive manufacturing apparatus of claim 1, wherein the dimensional compensation corresponding to the color value specified for the region of the object is determined by retrieving the dimensional compensation stored in a lookup table for the color value.

9. The additive manufacturing apparatus of claim 8, wherein the lookup table specifies the dimensional compensation for a range of color values, such that the color value specified for the region of the object is within the range.

10. The additive manufacturing apparatus of claim 1, wherein the dimensional compensation corresponding to the color specified for the region of the object is determined by:
computing the dimensional compensation by applying a specified function to a color value of the color.

11. The additive manufacturing apparatus of claim 1, wherein the color value comprises a first portion and a second portion,
wherein the first portion specifies the dimensional compensation to be applied to the region of the object, and the second portion specifies a color the region is to have when physically generated,
wherein the instructions are generated such that the region has the color specified by the second portion of the color value when the object is physically generated,
and wherein the color value is employed to both specify the dimensional compensation to be applied to the region of the object and the color of the region.

12. The additive manufacturing apparatus of claim 1, wherein the color for the region of the object is a first color for a first region of the object, and the dimensional compensation is a first dimensional compensation,
wherein the object model data further specifies a second color for a second region of the object, the second color different than the first color,
wherein the program code is executable by the processor to further determine a second dimensional compensation corresponding to the second color, the second dimensional compensation different than the first dimensional compensation, and
wherein the instructions are further generated such that the second dimensional compensation is applied to just the second region of the object.

13. A non-transitory computer-readable data storage medium storing program code executable by a processor to perform processing comprising:
receiving object model data representing a geometry of an object to be physically generated via additive manufacturing by an additive manufacturing apparatus;
receiving user selection of a region of the object, and user selection of a dimensional compensation to be applied to just the region of the object;
modifying the object model data to specify a color value for the region, the color value corresponding to the dimensional compensation to be applied to just the region of the object; and
sending the modified object model data to the additive manufacturing apparatus to physically generate the object such that the dimensional compensation is applied to just the region of the object.

14. The non-transitory computer-readable data storage medium of claim 13, wherein specification of the color value for the region by the modified object model data is employed just to notify the additive manufacturing apparatus of the dimensional compensation to be applied to just the region of the object.

15. The non-transitory computer-readable data storage medium of claim 13, wherein the geometry of the object is not modified in the received object model data based on the dimensional compensation during performance of the processing,
and wherein the dimensional compensation is instead reflected in the modified object model data in that the color value corresponding to the dimensional compensation is specified for the region to which the dimensional compensation is to be applied.

16. The non-transitory computer-readable data storage medium of claim 13, wherein the color value for the region of the object is a first color value for a first region of the object, the dimensional compensation is a first dimensional compensation, and the processing further comprises:
receiving user selection of a second region of the object, and user selection of a second dimensional compensation to be applied to just the second region, the second region different than the first region; and
modifying the object model data to specify a second color value for the second region, the second color corresponding to the second dimensional compensation to be applied to just the second region of the object.

17. A method comprising:
generating, by a processor executing program code and with user interaction, a geometry of an object to be physically generated via additive manufacturing by an additive manufacturing apparatus;
receiving, by the processor executing the program code, user selection of a region of the object, and user selection of a dimensional compensation to be applied to just the region of the object;
generating, by the processor executing the program code, object model data that represents the geometry of the object and that specifies a color value for the region, the color corresponding to the dimensional compensation to be applied to just the region of the object; and
sending, by the processor executing the program code, the object model data to the additive manufacturing apparatus to physically generate the object such that the dimensional compensation is applied to just the region of the object.

18. The method of claim 17, wherein specification of the color value for the region by the generated object model data is employed just to notify the additive manufacturing apparatus of the dimensional compensation to be applied to just the region of the object.

19. The method of claim 17, wherein the geometry of the object is not modified in the object model data based on the dimensional compensation during performance of the method,
and wherein the dimensional compensation is instead reflected in the object model data in that the color value corresponding to the dimensional compensation is specified for the region to which the dimensional compensation is to be applied.

20. The method of claim 17, wherein the color value for the region of the object is a first color value for a first region of the object, the dimensional compensation is a first dimensional compensation,
wherein the method further comprises receiving, by the processor executing the program code, user selection of a second region of the object, and user selection of a second dimensional compensation to be applied to just the second region, the second region different than the first region,
and wherein the object model data is further generated to specify a second color value for the second region, the second color value corresponding to the second dimensional compensation to be applied to just the second region of the object.
